(19) United States
(12) Patent Application Publication
(10) Pub. No.: US 2022/0062744 A1
(43) Pub. Date: Mar. 3, 2022

(54) Method Used As A Part of Playing Card Games

(71) Applicant: Perry B. Whittington, III, Charlotte, NC (US)

(72) Inventor: Perry B. Whittington, III, Charlotte, NC (US)

(21) Appl. No.: 17/403,225

(22) Filed: Aug. 16, 2021

Related U.S. Application Data
(60) Provisional application No. 63/072,422, filed on Aug. 31, 2020.

(51) Int. Cl. A63F 3/00; A63F 1/00

(52) U.S. Cl. CPC A63F 3/00157; A63F 2003/0017; A63F 2001/005; A63F 1/00

(57) ABSTRACT

The invention is a method that allows a player to determine the strength ranking of a poker hand from just one poker card. The method diagrams are part of different games that can be enjoyed by numerous players because the method requires less cards then regular poker to determine a poker hand and its strength ranking. These games can be played in a private setting or a casino setting.

### CROSS-REFERENCES TO RELATED APPLICATIONS

The present patent application/patent claims the benefit of priority of co-pending U.S. Provisional Patent Application No. 63/072,422, filed on Aug. 31, 2020, and entitled “ METHOD USED AS PART OF PLAYING A POKER BOARD GAME OR POKER CARD GAME SUITABLE FOR PRIVATE OR CASINO PLAY”, the contents of which are incorporated in full by reference herein.

### BACKGROUND OF THE INVENTION

### 1. Field of the Invention

The present invention relates to a poker based card game, and more specifically to a poker based method and games, wherein in the method a single card is indexing a poker hand. In a game, following an ante or a bet, the single card is selected to determine the poker hand that correlates to the single card.

### 2. Background of the Invention

Poker cards to play different poker games have been around a long time, as have casino style games. The rules of the games, the number of participants, the apparatus used to play, or platform needed to play specific games vary widely. The number of participants can be limited depending on the number of cards needed to form a playing hand based on the game you are playing. Playing a private poker game is generally done in small groups. In a casino setting, using a board type card game or just a card game, the number of participants also vary depending on the game that is being played.

There are very specific rules and terminology used when you play poker or casino games. Those can be learned but in some games the intangibles and the odds of drawing or being dealt a certain card are what make playing poker challenging and difficult to play at a high level. Poker games you play against other players using multiple cards can involve player strategy and knowing your odds of drawing or being dealt a card to finalize your best hand. It involves observing other players in an effort to figure out what their strategies are by the way they play, bet, and handle themselves. Do they have the potential hand they want you to think that they have. These intangibles make playing poker games more than just a learned skill. Being dealt cards, drawing cards, or placing bets to play a poker hand or a casino game is part of the sport that appeals to a lot of people. But for others it is intimidating and can be challenging. People love to play games and playing card games gives everyone that close interaction that generates fun and excitement.

People love to watch others play poker or casino type games. Most people have card games that they like to play whether it is for fun and relaxation or the challenge and competitive nature of the game. This leaves plenty of space for different types of card games, including games that are based solely on the luck of the draw where no knowledge of odds are needed to win. This is appealing to some players. If you introduce betting into the game, it can enhance some of the intangibles that people enjoy. Most card games just require a deck of cards and a table where the players can sit and be dealt or draw their cards and play their hand. Most casino style games generally require more space but are still limited in scope by the method and the set up needed for the players to bet and play the game. This limitation also includes the number of players. The use of dice or other mechanical devices also limit the number of players.

Casino poker games have been popular since the late 1980's when the games “Caribbean Stud” (disclosed in U.S. Pat. No. 4,836,553 to Suttle, et al in 1989), “Double Down Stud” (disclosed in U.S. Pat. No. 5,167,413 to Fulton in 1992), and “Let It Ride” (disclosed in U.S. Pat. No. 5,288,081 to Breeding in 1994) were introduced. Later, “Three Card Poker” (disclosed in U.S. Pat. No. 5,685,774 to Webb in 1997), was also introduced. These are the four most popular casino poker games today.

While these four games enjoy the most commercial success, other casino poker games offer games that blend poker with other familiar casino games. Some games use wild cards, and some use progressive jackpot payouts to players holding select poker cards. These new games provide insight into the broad categories into which these new games fit and in some cases encompass the new art in casino poker games.

Recently patented casino poker games use either: (1) non-standard additions that could discourage, confuse and drive off many recreational players; (2) content that could be hard to administer in a casino table game setting; (3) content could have limited appeal to traditional poker players; or (4) require long waits before a poker hand is identified that could decrease interest or increase anxiety among the players.

### SUMMARY OF THE INVENTION

The invention is a poker card based method used as a part of different card games, wherein the method utilizes a single playing card from a common deck of cards and indexes it to a specific poker hand. Not counting wild cards and a single high card, there are eight types of poker hands, in ascending order they are: one pair, two pair, three of a kind, straight, flush, full house, four of a kind, and straight flush. The term flush indicates that all of the five cards forming the hand are of the same suit, where the suits are spades, hearts, diamonds and clubs. In ranking, note that there is no distinction in rank between Ace high straight flushes. But for other straight flushes there is distinction in rank based on the high card in the hand. A queen high straight flush beats a jack high straight flush.

A first aspect of the invention is a method to generate a specific poker hand from the highest to a lowest, using conventional poker rules for each of a group of unique poker hands.

A second aspect of the invention is indexing playing cards from a common deck of cards to a specific poker hand, wherein each of the group of poker hands has a strength ranking.

A third aspect of the invention is that it only takes one playing card to identify a winner, in contrast to most other poker type games that require at least five or more cards.

A fourth aspect of the invention is the strength ranking is derived from the indexed playing card and its linked specific poker hand.

A fifth aspect of the invention is utilizing this correlation between the indexed playing card and the specific poker hand to play new casino and private games.

A sixth aspect of the invention is the winners of different games are determined by the indexed playing card identified.

A seventh aspect of the invention is that players will know what specific poker hand they have after receiving only one playing card and can place bets on that poker hand without having to wait for five or more cards to determine their poker hand.

An eighth aspect of the invention is that bets can be placed in a casino setting on what playing card will be identified by the house and also bets can be placed on that card's suit, the specific poker hand, or the rank of the poker hand that is linked to that playing card.

A ninth aspect of the invention is that games can be played in a private setting involving more players than conventional poker games where winners are determined based on the rules of the different games.

A tenth aspect of the invention is that during a game, a playing card, or a randomly generated emblematic playing card (ecard), is displayed to a group of players or is individually dealt to each player in the game. This playing card is linked to one specific poker hand. This method decreases the playing time for each game.

An eleventh aspect of the invention is that the games are based on the luck of draw and the one indexed playing card is the basis for determining winners and losers. The invented method involves fewer cards to establish a player's poker hand, which allows more players to participate in a card game at one time. It also does not require any real knowledge of poker strategy or playing odds to enjoy the game. The invented method eliminates the uncertainty participants feel while waiting to receiving multiple cards and possibly betting until they determine their poker hand. Now the participants quickly know what their poker hand is and bet accordingly.

### BRIEF DESCRIPTION OF THE DRAWINGS

The foregoing invention will become readily apparent by referring to the following detailed description and the appended drawings in which:

FIG. 1 illustrates a 52 card circular diagram used in a method of playing a card game;

FIG. 2 illustrates a 40 playing card circular diagram, plus two jokers, used in a method of playing a card game;

FIG. 3 shows an alternate rectangular diagram that could be used to duplicate the specifics shown in FIG. 2, wherein the rectangular diagram is particularly well suited for a method of playing a card game;

FIG. 4a and FIG. 4b is a tabulation of the 52 indexed cards shown in the circular diagram of FIG. 1;

FIG. 5a and FIG. 5b is a tabulation of the 40 indexed cards shown in the circular diagram of FIG. 2;

FIG. 6 is a flow chart detailing a method for correlating a playing card to a specific poker hand and strength ranking;

FIG. 7a and FIG. 7b is a flow chart detailing the steps used to play a card game; and

FIG. 8a and FIG. 8b is a flow chart detailing the steps used to play a card game in a casino type setting.

### DETAILED DESCRIPTION OF THE INVENTION

Using the invented method each different playing card is indexed to a specific poker hand. With no wildcards, and neglecting single high cards, there are eight different “types” of poker hands. They are one pair, two pair, three of a kind, straight, flush, full house, four of a kind, and straight flush. The “Suits” (spades, hearts, diamonds and clubs), carry no weight as is the case in the standard rules of poker.

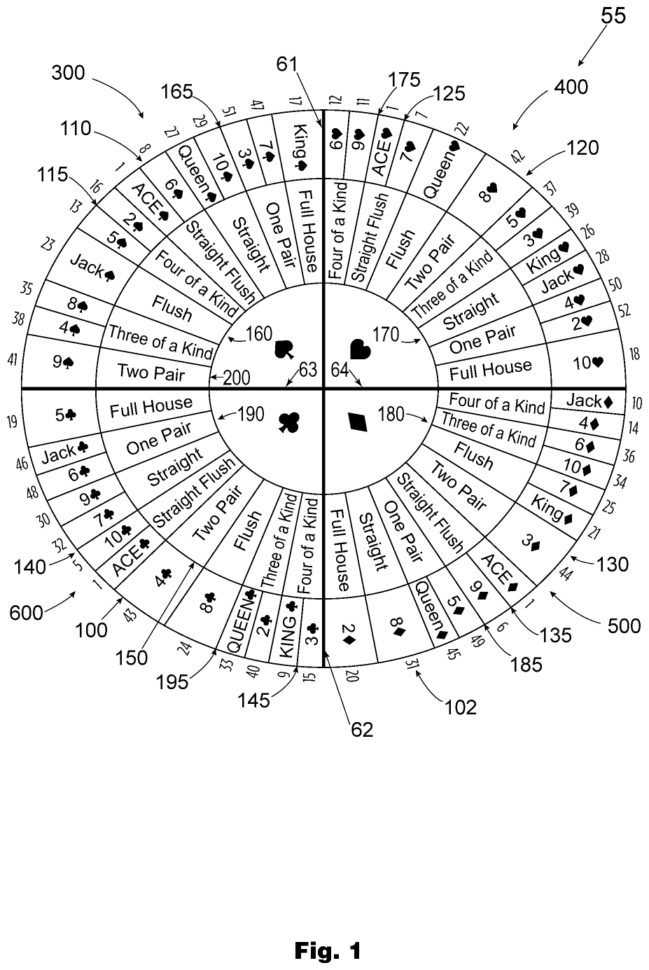

FIG. 1 is a circular diagram 55 showing a preferred embodiment which illustrates diagrammatically the correlation of the strength ranking of a plurality of types of poker hands grouped by a suit quadrant. The circular diagram facilitates playing a card game that uses indexed playing cards. The circular diagram includes three overlapping circles having a common center. As shown in circular diagram 55, there is an inner circle 200, a middle circle 150, and an outer circle 100. The inner circle 200 is identified by its outer edge 200. The middle circle 150 is adjacent to the inner circle 200 and is identified by its outer edge 150. The outer circle 100 is adjacent to the middle circle 150 and is identified by its outer edge 100.

The three circles are identified by their outer edges being the outer circle 100, the middle circle 150, and the inner circle 200. The three circles 100, 150, and 200 are divided into four equal quadrants that are separated by the north-south axis lines 61, 62 and the east-west axis lines 63, 64. Each of the four quadrants are further identified by the card suit symbols shown in each quadrant of the inner circle 200. The Spade quadrant 300 is shown to be between the north axis 61 and the west axis 63. The Heart quadrant 400 is shown to be between the north axis 61 and the east axis 64. The Diamond quadrant 500 is shown to be between the east axis 64 and the south axis 62. The Club quadrant 600 is shown to be between the south axis 62 and the west axis 63. The middle circle 150 is broken up into sections 160, 170, 180, and 190 located respectively in each of the suit quadrants 300, 400, 500, and 600. Section 160 of the middle circle 150 contains a plurality of eight spaces, each containing eight different poker hands. They are one pair, two pair, three of a kind, straight, flush, full house, four of a kind, and straight flush. Sections 170, 180, and 190 of the middle circle 150 also contain a plurality of eight spaces each of which contain the same eight different poker hands as section 160 of the middle circle 150. Each of the four quadrants 300, 400, 500, and 600 contain seven lines running from the outer part of the inner circle 200 to the outer edge of the outer circle 100. These seven lines separate the eight different poker hands in each of the above quadrants in the middle circle 150 and the card or cards in the outer circle 100 that are indexed to that specific poker hand. The plurality of those seven lines 165 are in the spades quadrant 300. The plurality of those seven lines 175 are in the heart quadrant 400. The plurality of those seven lines 185 are in the diamond quadrant 600. The plurality of those seven lines 195 are in the club quadrant 600. The outer circle 100 is broken up into sections located in each of the suit quadrants 300, 400, 500, and 600. These are sections 110, 120, 130, and 140 respectively. They contain a plurality of thirteen spaces that contain the thirteen different playing cards of the suit that quadrant represents. Those are the Ace, King, Queen, Jack, 10, 9, 8, 7, 6, 5, 4, 3 and 2. These playing cards are specifically placed in each section 110, 120, 130, and 140 of the outer circle 100 and are indexed to a specific adjacent poker hand in sections 160, 170, 180, and 190 respectively of the middle circle 150. Each section 110, 120, 130, and 140 of the outer circle 100 has a plurality of five lines 115, 125, 135, 145 respectively drawn between the outer edge of the middle circle 150 and outer edge of the outer circle 100 that separate two cards that are adjacent to and indexed to one of the specific poker hands in the middle circle 150. The plurality of the five lines 115 in section 110 of the outer circle 100 separate the four and the eight of spades, the two and the five of spades, the six and the Ace of spades, the ten and the queen of spades, and the three and the seven of spades. The plurality of the five lines 125 in section 120 of the outer circle 100 separate the six and the nine of hearts, the seven and the Ace of hearts, the three and the five of hearts, the Jack and the King of hearts, and the two and four of hearts. The plurality of the five lines 135 in section 130 of the outer circle 100 separate the four and the Jack of diamonds, the six and the ten of diamonds, the seven and the King of diamonds, the nine and the Ace of diamonds, and the five and the Queen of diamonds. The plurality of the five lines 145 in section 140 of the outer circle 100 separate the three and the King of clubs, the two and the Queen of clubs, the ten and the Ace of clubs, the seven and the nine of clubs, and the six and the Jack of clubs. The playing cards in section 110 of the outer circle 100 are indexed to the adjacent specific poker hands in section 160 of the middle circle 150. The playing cards in section 120 of the outer circle 100 are indexed to the adjacent specific poker hands in section 170 of the middle circle 150. The playing cards in section 130 of the outer circle 100 are indexed to the adjacent specific poker hands in section 180 of the middle circle 150. The playing cards in section 140 of the outer circle 100 are indexed to the adjacent specific poker hands in section 190 of the middle circle 150.

FIG. 1 demonstrates the indexing between the sections 110, 120, 130, and 140 containing the plurality of the indexed playing cards on the outer circle 100, the correlating specific poker hands are in sections 160, 170, 180, and 190 of the middle circle 150, and the poker card suits in quadrants 300, 400, 500, and 600 of the inner circle 200.

There are fifty-two whole numbers that are located on the outer edge of the outer circle 100 that represent the strength ranking associated with the adjacent playing card and the specific poker hand to which it is indexed. The plurality of these fifty-two hand rank numbers are the strength ranking 102 for the indexed playing card and its adjacent specific poker hand. For example the strength ranking 102 is pointed to the number 31. The indexing playing card adjacent to the whole number 31 is the eight of diamonds in the diamond quadrant 500. The eight of diamonds (8♦) is indexed to a specific poker hand, which is a straight, and the strength ranking of thirty-one out of a possible fifty-two strength rankings.

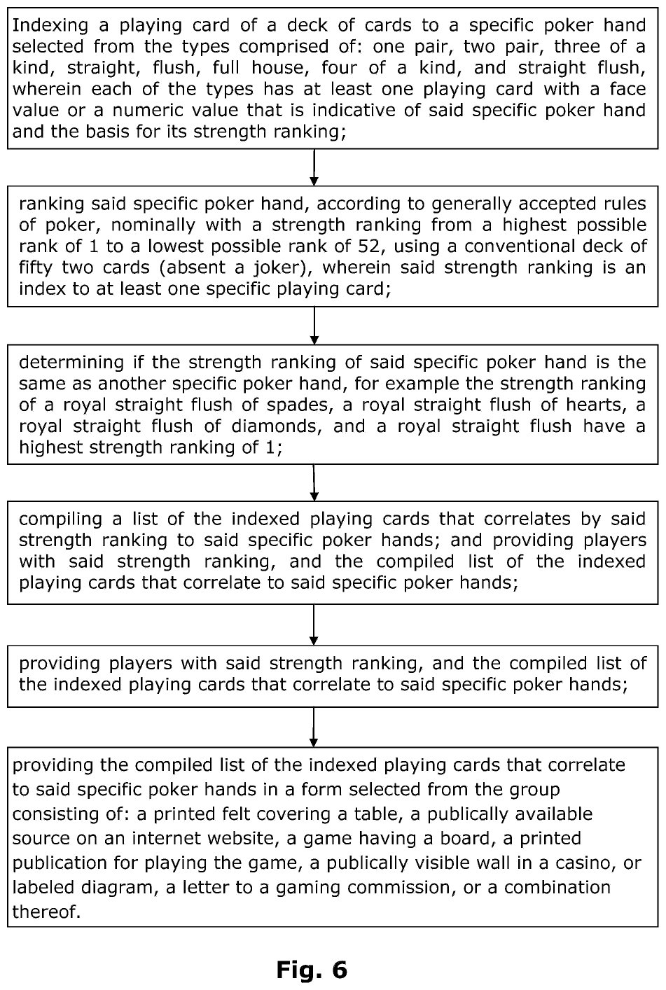

A method for correlating a playing card to a specific poker hand, wherein the steps are enumerated in a flow chart format as shown in FIG. 6. The method includes the steps of: indexing a playing card of a deck of cards to a specific poker hand selected from the types that include: one pair, two pair, three of a kind, straight, flush, full house, four of a kind, and straight flush, wherein each of the types has at least one playing card with a face value or a numeric value that is indicative of a specific poker hand and a basis for its strength ranking. The strength ranking is based on generally accepted rules of poker, wherein the strength ranking is from a highest possible rank of 1 to a lowest possible rank of 52, using a conventional deck of fifty two cards (absent a joker). The strength ranking is an index to at least one specific playing card. The method includes determining if the strength ranking of a specific poker hand is the same as another specific poker hand. For example the strength ranking of a royal straight flush of spades, a royal straight flush of hearts, a royal straight flush of diamonds, and a royal straight flush of clubs have a highest strength ranking of one. The method includes compiling a list of the indexed playing cards that correlates by the strength ranking of specific poker hands. The method includes providing players with the strength ranking, and the compiled list of the indexed playing cards that correlate to the specific poker hands.

The method for correlating a playing card to a specific poker hand can further include the steps of: providing the compiled list of the indexed playing cards that correlate to said specific poker hands in a form selected from the group consisting of: a printed felt covering a table, a publically available source on an internet website, a game having a board, a printed publication for playing the game, a publically visible wall in a casino, a labeled diagram, a letter to a gaming commission, or a combination thereof.

The circular diagram 55 shown in FIG. 1 is a compiled list of a complete deck (52 cards) of indexed playing cards that correlate to specific poker hands. The circular diagram 55 easily fits on a table, a wall, and electronic screens such as on a webpage.

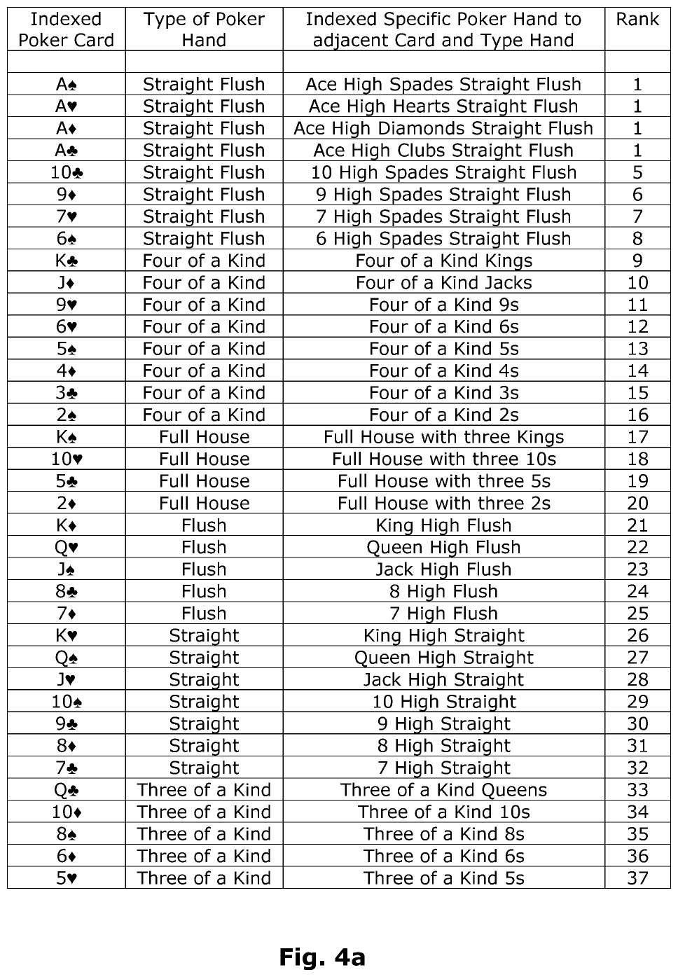

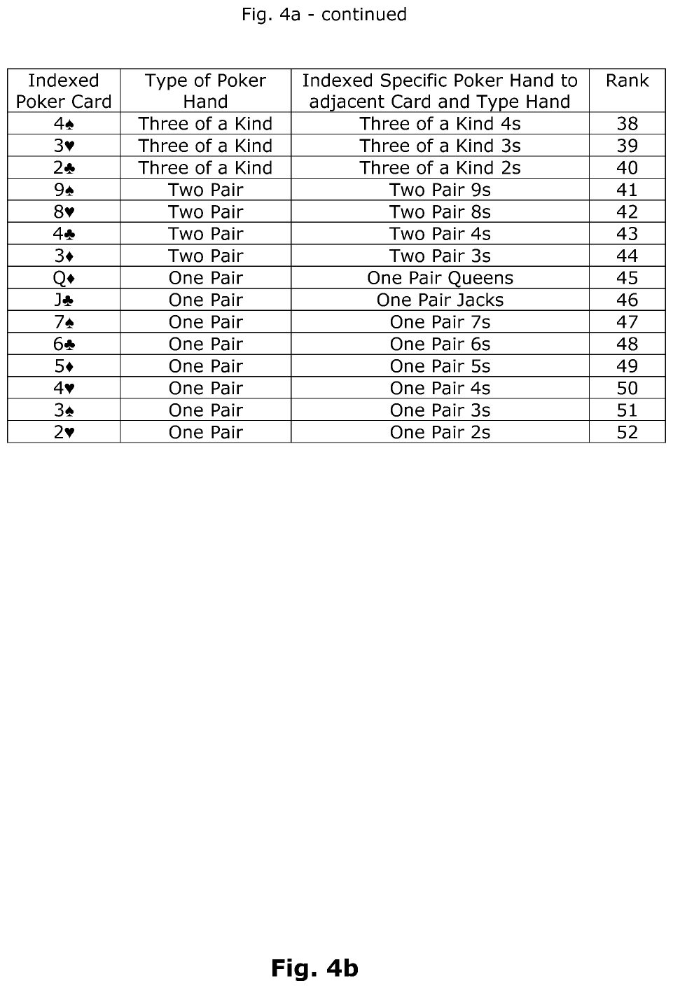

For the reader's convenience a complete tabular list of indexed playing cards that correlate to specific poker hands is shown in FIGS. 4a and 4b.

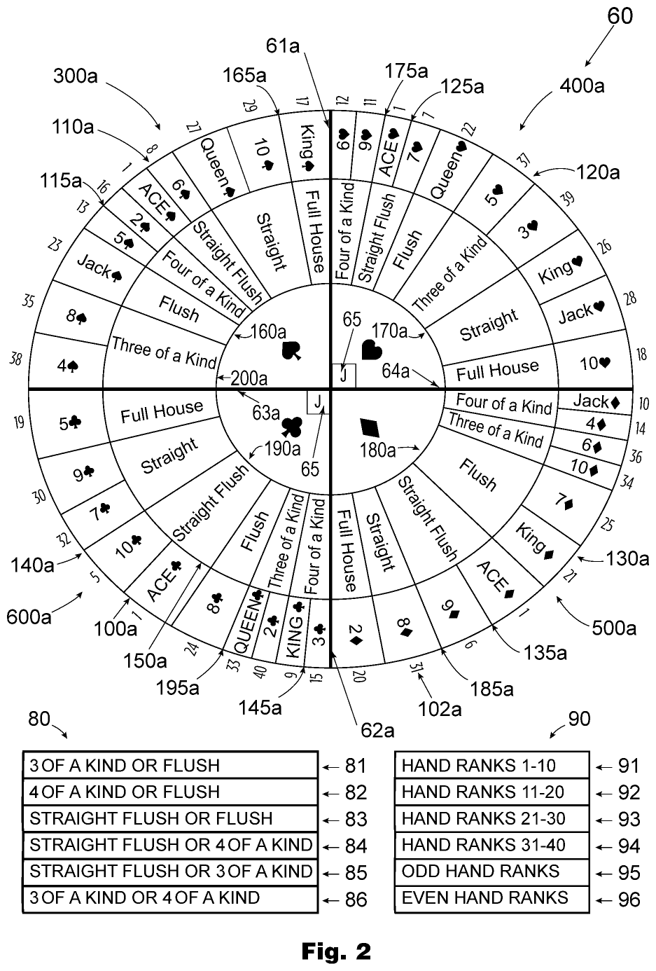

Another circular diagram 55a, that is shown in FIG. 2 is a compiled list of a subset of a complete deck, using only 40 indexed playing cards plus two jokers. The indexed playing cards are the only ones that correlate to specific poker hands. As shown in FIG. 2, the circular diagram 55a has a plurality of betting zones 80, 90 with betting spaces 81-86, 91-96.

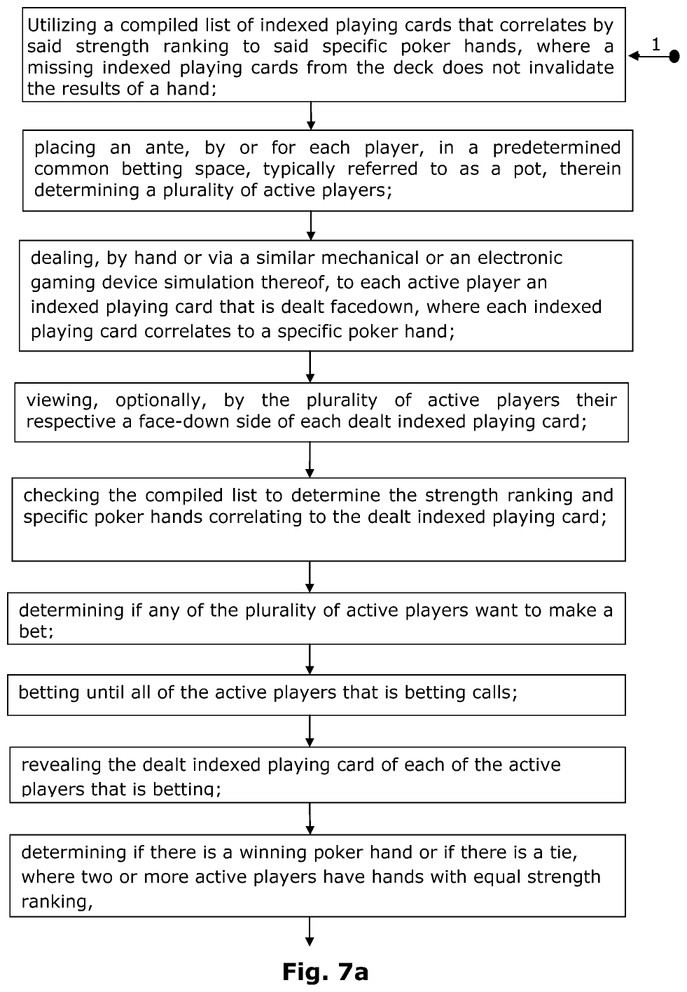

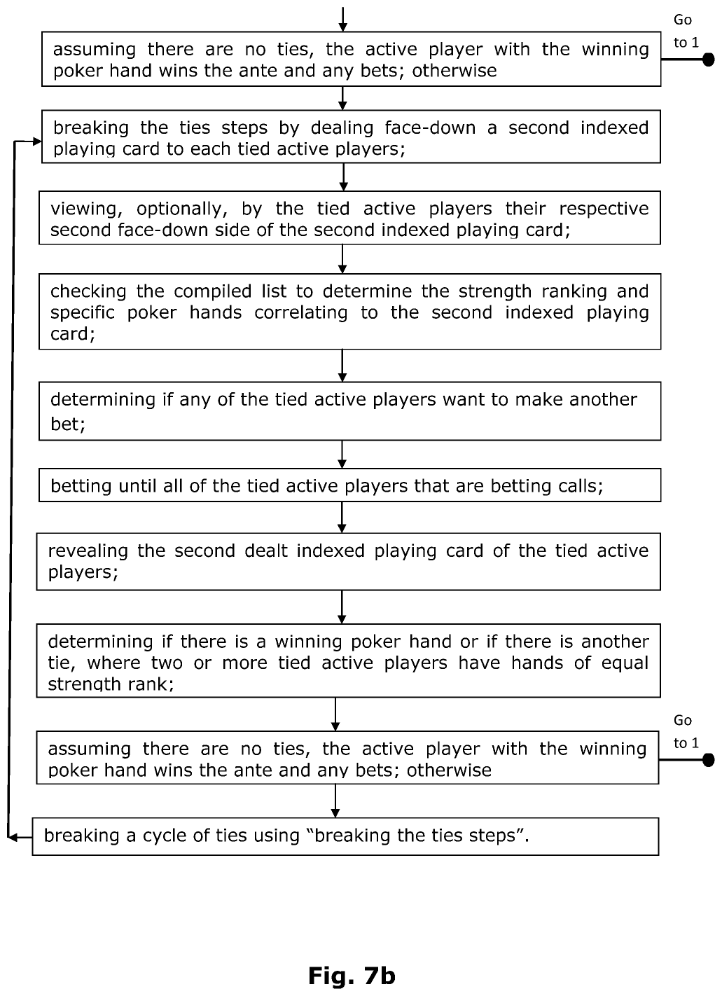

A method, using the compiled list, to play a card game is shown in FIGS. 7a and 7b as a flow diagram. This game can be played with two or more players.

The method for playing a card game includes the steps of: utilizing the compiled list which correlates indexed playing cards by the strength ranking to specific poker hands, where a missing indexed playing card from the deck does not invalidate the results of a hand; placing an ante, by or for each player, in a predetermined common betting space, typically referred to as a pot, therein determining a plurality of active players; dealing, by hand or via a similar mechanical or an electronic gaming device simulation thereof, to each active player an indexed playing card that is dealt facedown, where each indexed playing card correlates to a specific poker hand; viewing, optionally, by the plurality of active players their respective face-down side of each dealt indexed playing card; checking the compiled list to determine the strength ranking and specific poker hand correlating to the dealt indexed playing card; determining if any of the plurality of active players want to make a bet; betting until all of the active players that are betting calls; revealing the dealt indexed playing card of each of the active players that are betting; determining if there is a winning poker hand or if there are ties, where two or more active players have hands of equal strength rank; assuming there are no ties, the active player with the winning poker hand wins the ante and any bets; breaking the ties steps by dealing face-down a second indexed playing card to each tied active players; viewing, optionally, by the tied active players their respective second face-down side of the second indexed playing card; checking the compiled list to determine the strength ranking and specific poker hands correlating to the second indexed playing card; determining if any of the tied active players want to make another bet; betting until all of the tied active players that are betting calls; revealing the second dealt indexed playing card of the tied active players; determining if there is a winning poker hand or if there is another tie, where two or more tied active players have hands of equal strength rank; assuming there are no ties, the active player with the winning poker hand wins the ante and any bets and the method cycles back to step 1. If there is a tie continue with the step of “breaking the ties steps”.

The method for playing a card game can further include the steps of: providing the compiled list as a labeled diagram showing the indexed poker playing cards that correlate to specific type poker hands via their strength ranking in a format suitable for playing the card game. A preferred format includes a casino printed felt covering a table.

For example, a player identifies their playing card as the five of clubs. Using the circular diagram 55 in FIG. 1 the player locates the five of clubs on the outer circle 100 in the Club quadrant 600. The player then identifies the specific poker hand that is adjacent to the five of clubs in the same quadrant on the middle circle 150. The circular diagram 55 shows that the specific poker hand that is adjacent to the five of Clubs is a Full House. A full house consists of three of a kind and a pair. The three of a kind are three cards of the same value, wherein their face or numeric value determines the strength ranking of the hand, even if the pair has higher cards. The strength ranking 19 is indexed to the five of clubs and the full house poker hand, indicating that the five of clubs is one of the three similar cards of the full house hand.

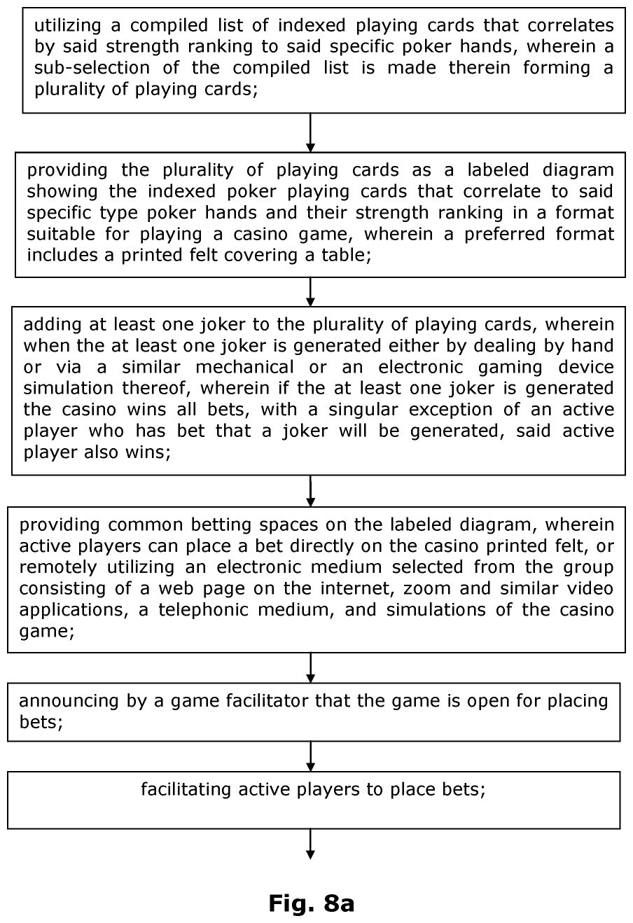

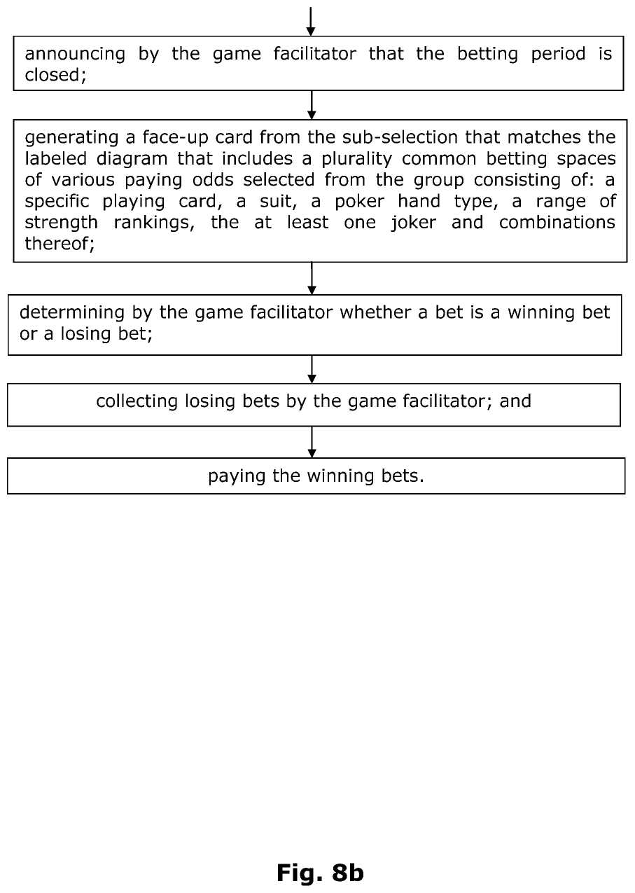

FIG. 2 is a circular diagram 55a based on a subset of the indexed playing cards in the compiled list. The subset utilizes 40 indexed playing cards and two jokers. The circular diagram 55a can be utilized when playing a card game, described herein, and is anticipated to be suitable for other card games. The method for playing a card game is described in the flow chart illustrated in FIGS. 8a-8b.

The circular diagram 55a is made up of three overlapping circles having a common center. The circles are an inner circle 200a, a middle circle 150a, and an outer circle 100a. The inner circle is identified by its outer edge 200a. The middle circle 150a is adjacent to the inner circle 200a and is identified by its outer edge 150a. The outer circle 100a is adjacent to the middle circle 150a and is identified by its outer edge 100a.

The three circles are identified by their outer edges being the outer circle 100a, the middle circle 150a, and the inner circle 200a. The three circles are divided into four equal quadrants that are separated by the north-south axis lines 61a, 62a and the east-west axis lines 63a, 64a. Each of the four quadrants is further identified by the card suit symbols shown in each quadrant of the inner circle 200a. The Spade quadrant 300a is shown to be between the north axis 61a and the west axis 63a. The Heart quadrant 400a is shown to be between the north axis 61a and the east axis 64a. The Diamond quadrant 500a is shown to be between the east axis 64a and the south axis 62a. The Club quadrant 600a is shown to be between the south axis 62a and the west axis 63a. The middle circle 150a is broken up into sections 160a, 170a, 180a, and 190a located respectively in each of the suit quadrants 300a, 400a, 500a, and 600a. Section 160a of the middle circle 150a contains a plurality of six spaces each containing six different poker hands. Those being three of a kind, straight, flush, full house, four of a kind, and straight flush. Sections 170a, 180a, and 190a of the middle circle 150a also contain a plurality of six spaces each of which contain the same six different poker hands as section 160a of the middle circle 150a. Each of the four quadrants 300a, 400a, 500a, and 600a contain a plurality of five lines 165a, 175a, 185a, and 195a respectively running from the outer part of the inner circle 200a to the outer edge of the outer circle 100a that separate the six different poker hands in each of the above quadrants in the middle circle 150a and the card or cards in the outer circle 100a that are indexed to that specific poker hand. The plurality of the five lines 165a are in the spades quadrant 300a. The plurality of the five lines 175a are in the heart quadrant 400a. The plurality of the five lines 185a are in the diamond quadrant 500a. The plurality of the five lines 195a are in the club quadrant 600a. The outer circle 100a is broken up into sections 110a, 120a, 130a, and 140a located in each of the suit quadrants 300a, 400a, 500a, and 600a respectively. The sections 110a, 120a, 130a, 140a each contain a plurality of ten spaces that contain ten playing cards of the suit that they represent. They are the Ace, King, Queen, Jack, 10, 8, 6, 5, 4, and 2 in section 110a of the spades quadrant 300a. They are the Ace, King, Queen, Jack, 10, 9, 7, 6, 5, and 3 in section 120a of the hearts quadrant 400a. They are the Ace, King, Jack, 10, 9, 8, 7, 6, 4, and 2 in section 130a of the diamonds quadrant 500a. They are the Ace, King, Queen, 10, 9, 8, 7, 5, 3, and 2 in section 140a of the clubs quadrant 600a. The playing cards are specifically placed in each section 110a, 120a, 130a, and 140a of the outer circle 100a and are indexed to the specific adjacent poker hand in sections 160a, 170a, 180a, and 190a respectively of the middle circle 150a. Each section 110a, 120a, 130a and 140a of the outer circle 100a has a plurality of four short lines 115a, 125a, 135a, and 145a, which extend from the outer edge of the middle circle 150a and outer edge of the outer circle 100a that separate two playing cards that are adjacent to and indexed to one of the specific poker hands in the middle circle 150a. The plurality of the four short lines 115a in section 110a of the outer circle 100a separate the four of spades and the eight of spades, the two of spades and five of spades, the six of spades and Ace of spades, and the ten of spades and Queen of spades. The plurality of the four short lines 125a in section 120a of the outer circle 100a separate the six of hearts and nine of hearts, the seven of hearts and Ace of hearts, the three of hearts and the five of hearts and the Jack of hearts and King of hearts. The plurality of the four short lines 135a in section 130a of the outer circle 100a separate the four of diamonds and the Jack of diamonds, the six of diamonds and the ten of diamonds, the seven of diamonds and the King of diamonds, and the nine of diamonds and the Ace of diamonds. The plurality of the four short lines 145a in section 140a of the outer circle 100a separate the three of clubs and King of clubs, the two of clubs and the Queen of clubs, the ten of clubs and the Ace of clubs, and the seven of clubs and nine of clubs. The playing cards in section 110a of the outer circle 100a are indexed to the adjacent specific poker hands in section 160a of the middle circle 150a. Playing cards in section 120a of the outer circle 100a are indexed to the adjacent specific poker hands in the section 170a of the middle circle 150a. The playing cards in section 130a of the outer circle 100a are indexed to the adjacent specific poker hands in section 180a of the middle circle 150a. The playing cards in section 140a of the outer circle 100a are indexed to the adjacent specific poker hands in section 190a of the middle circle 150a.

There are forty whole numbers that are located on the outer edge of the outer circle 100a that represent the strength ranking 102a associated with the adjacent playing cards and the specific poker hand to which it is indexed. The plurality of these forty hand rank numbers are represented by the strength ranking 102a reference number, located adjacent to the eight of diamonds in the diamond quadrant 500a, showing the eight of diamonds is indexed to and is part of a specific poker hand, a straight, which is ranked thirty-one out of the forty hand ranks shown.

In addition to the forty playing cards in the spaces of the outer circle 100a there are two square joker spaces 65 at the center of two quadrants of the inner circle 200a that are spaces to place bets on the two jokers in the card deck that are used to play this embodiment of the card game. These two jokers are not indexed to a specific poker hand, but are just stand alone cards in the card deck and are just used, in the case of a casino setting, to give the house an edge.

The game diagram in FIG. 2 is an illustration of a game that is played in a group type of setting with a facilitator or other means used to identify one playing card in the about forty-two card deck that will be used to determine the winners in all the bets placed in the game. Bets can be placed by multiple players on betting spaces that include a playing card space or spaces on the outer circle 100a, a specific poker hand space or spaces on the middle circle 150a, on one or more of the four card suit spaces that comprise the inner circle 200a, on one or more of the six rectangular boxes 81, 82, 83, 84, 85, or 86 contained in the betting block 80 each of which contain two poker hands, and on one or more of the six rectangular boxes 91, 92, 93, 94, 95, or 96 contained in the betting block 90, each of which contain different strength rankings 102a, which are all listed as whole numbers around the outside edge of the outer circle 100a. After the players have placed their bets, one playing card is identified from the deck of forty playing cards and two jokers. Since the jokers are just stand alone cards and are not indexed to anything else, if one of them is identified, the only way a player can win is if they placed a bet on one of the joker spaces 65 at the center of the inner circle 200a. If no bets were placed in the joker spaces 65 and a joker is identified, there are no winners except the house. If one of the forty playing cards is identified, any of the players who placed a bet on that specific playing card or on the specific poker hand, the card suit, or the strength ranking that is linked to that specific playing card wins and will be paid by the house at a designated payout rate per individual bet.

A flow chart for a method to play the game is illustrated in FIGS. 8a and 8b. It is anticipated that the game could be played in gaming venues such as a casino with said method comprising the steps of: utilizing a compiled list of indexed playing cards that correlates by said strength ranking to said specific poker hands, wherein a subset of the compiled list is made therein forming a plurality of playing cards, where a missing indexed playing card from the deck does not invalidate the results of a hand; providing the plurality of playing cards as a labeled diagram showing the indexed poker playing cards that correlate to said specific type poker hands and their strength ranking in a format suitable for playing the casino game, wherein a preferred format includes a printed felt covering a table; adding at least one joker to the plurality of playing cards, wherein when the at least one joker is generated either by dealing by hand or via a similar mechanical or an electronic gaming device simulation thereof, wherein if the at least one joker is generated the casino wins all bets, with a singular exception of an active player who has bet that a joker will be generated, said active player also wins; providing common betting spaces on the labeled diagram, wherein active players can place a bet directly on the casino printed felt, or remotely utilizing an electronic medium selected from the group consisting of a web page on the internet, zoom and similar video applications, a telephonic medium, and simulations of the game; announcing by a game facilitator that the game is open for placing bets; facilitating active players to place bets; announcing by the game facilitator that the betting period is closed; generating a face-up card from the sub-selection that matches the labeled diagram that includes a plurality of common betting spaces of various paying odds selected from the group consisting of: a specific playing card, a suit, a poker hand type, a range of strength rankings, the at least one joker and combinations thereof; determining by the game facilitator whether a bet is a winning bet or a losing bet; collecting losing bets by the game facilitator; and paying the winning bets. It is anticipated that the game facilitator may periodically need to explain the paying odds on the labeled diagram so that, collectively, the active players better understand the game.

The method further comprising the steps of: providing active players common betting spaces to bet on a group of betting spaces consisting of: a plurality of single indexed poker playing cards; each of the four card suits, one or more of the eight types of poker hands, a plurality of the rankings of a type of poker hand, and combinations thereof.

FIG. 1 and FIG. 2 demonstrate the indexing and correlation between the playing cards on the outer circles 100 and 100a, the specific poker hands in the middle circles 150 and 150a, and the playing card suits in quadrants 300 and 300a, 400 and 400a, 500 and 500a, and 600 and 600a of the inner circles 200 and 200a, and the hand ranks 102 and 102a that enables the method to be used in methods of playing card games previously described.

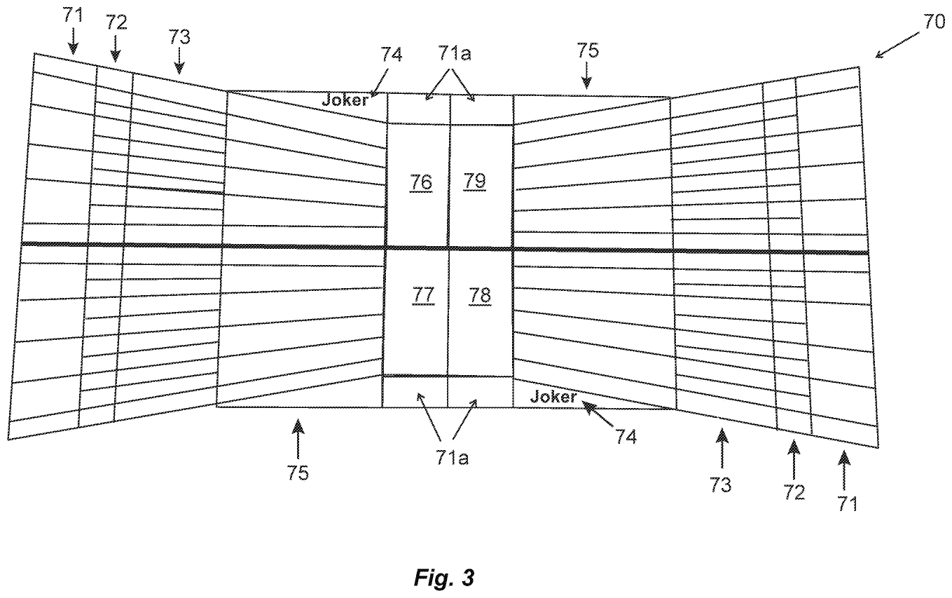

FIG. 3 is a generalized rectangular diagram 70, which is a variation of the circular diagram 55a. The rectangular diagram has an elongated shape, which conforms to standard casino tables, which are frequently rectangular. In one embodiment, the rectangular diagram 70 is stenciled on the felt covering a table or otherwise displayed, where the betting spaces can be used as described in FIG. 2 of the circular diagram 55a. Each of the columns 71 have a plurality of twelve blank spaces that are suitable as betting spaces for specific poker hands and strength rankings. Betting spaces 71a contain four blank spaces for additional strength ranking bets. Both columns 72 contain a plurality of twenty blank betting spaces that can be used to identify the strength ranking of the specific poker hands adjacent to them. Both columns 73 contain a plurality of twenty blank betting spaces that can be used to identify the indexed playing cards used in the game. Both spaces 74 contain a betting space to bet on the jokers that are in the deck and part of the game. Both columns 75 contain a plurality of thirteen blank betting spaces, twelve of which can be used to identify specific poker hands. Betting spaces 76, 77, 78, and 79 contain one of the four different card suits, being spades, hearts, diamonds, and clubs.

FIG. 4a and FIG. 4b are a format of the information shown in FIG. 1. of a preferred embodiment but is presented in a linear format which still shows the method that demonstrates the indexing and correlation between one playing card, its card suit, the specific poker hand, and the poker hands strength ranking.

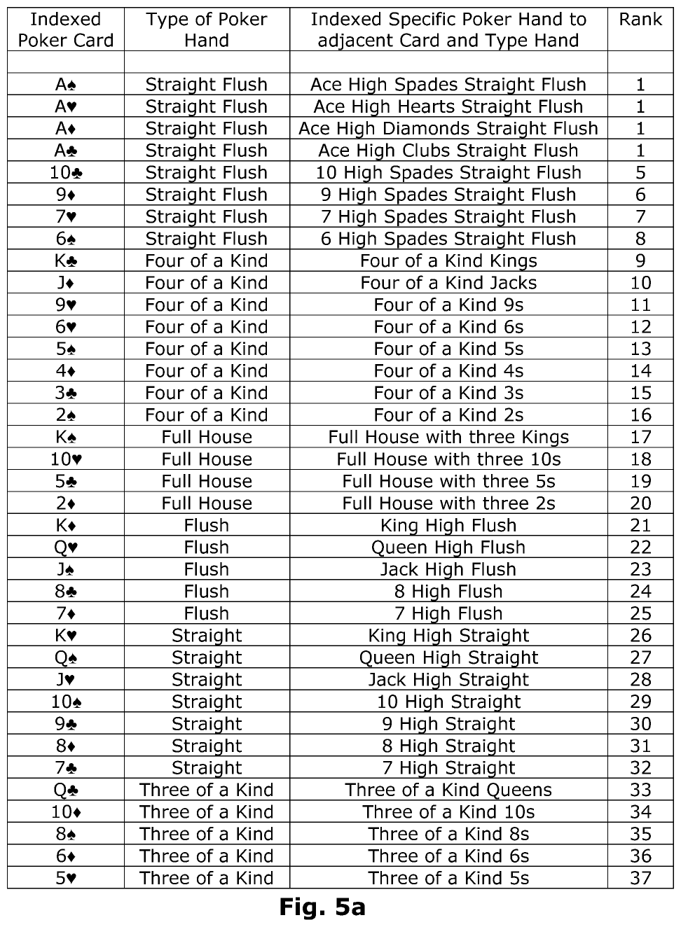

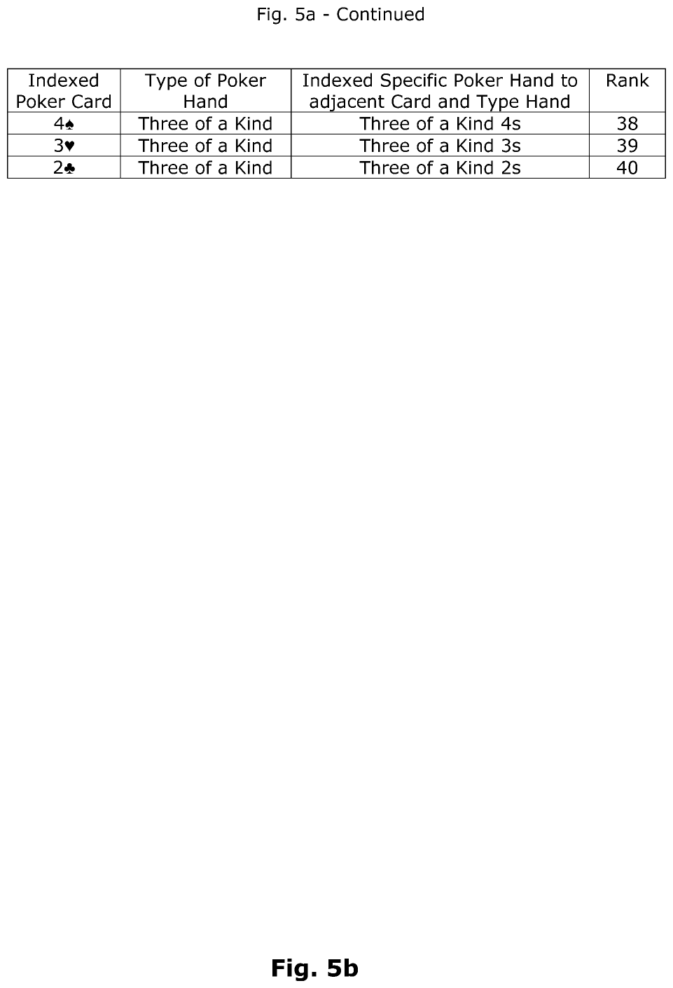

FIG. 5a and FIG. 5b are a linear representation of the information shown and described in FIG. 2. The two joker spaces 65 that are included in FIG. 2 are just stand alone cards that are not indexed to anything. In a casino game they are used to give what is called the house edge. In the casino type game players can bet on a specific playing card or cards, on a specific card suit or suits, on a specific poker hand or hands, and/or on the strength ranking or rankings of the different poker hands. After bets are placed, one playing card from the card deck is presented to the players and the winners are determined based on the playing card selected. Any players who bet on the specific playing card selected or on its card suit, along with the specific poker hand or the strength ranking of the poker hand indexed to the playing card selected are winners.

FIG. 6 is an illustration showing the method of correlating a playing card to a specific poker hand and strength ranking.

FIG. 7a and FIG. 7b is an illustration showing the steps of playing a card game.

FIG. 8a and FIG. 8b is an illustration showing the steps of playing the casino type game.

In private or casino type of games the illustration of FIG. 1, FIG. 2, or FIG. 3 can be placed on a board, other type of substrate, or presented using some kind of visual or virtual process in which the games are played either manually or electronically.

For the purposes of this disclosure, the term “board” means a conventional stiffened surface on which a board game may be played. This term is also intended to encompass any other surface, such as a gaming table, a video screen or other surfaces where the invention and it's embodiments are viewed using other visual or virtual means on which such games are commonly played by either mechanical or electronic means.

While the above described embodiments of the invention are generally played by two or more players, it will be appreciated by those skilled in the art that these games may be played by a single player against, for example, a house entity in the case of a commercial gaming enterprise.

While the present invention has been described in connection with the patent figure embodiments, it is to be understood that other similar embodiments may be used or modifications and additions may be made to the described embodiment for performing the same function of the present invention without deviating there from. Therefore, the present invention should not be limited to my single preferred embodiment, but rather construed in breadth and scope in accordance with the recitation of the appended claims.

Moreover, the description and illustration of the invention is by way of example, and the scope of the invention is not limited to the exact details shown or described.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

What is claimed is:

1. A method for correlating a playing card to a specific poker hand, wherein said method comprising the steps of:
indexing a playing card of a deck of cards to a specific poker hand selected from the types comprised of: one pair, two pair, three of a kind, straight, flush, full house, four of a kind, and straight flush, wherein each of the types has at least one playing card with a face value or a numeric value that is indicative of said specific poker hand and the basis for its strength ranking;
ranking said specific poker hand, according to generally accepted rules of poker, nominally with a strength ranking from a highest possible rank of 1 to a lowest possible rank of 52, using a conventional deck of fifty two cards (absent the jokers), wherein said strength ranking is an index to at least one specific playing card;
determining if the strength ranking of said specific poker hand is the same as another specific poker hand, for example the strength ranking of a royal straight flush of spades, a royal straight flush of hearts, a royal straight flush of diamonds, and a royal straight flush have a highest strength ranking of 1;
compiling a list of the indexed playing cards that correlates by said strength ranking to said specific poker hands; and
providing players with said strength ranking, and the compiled list of the indexed playing cards that correlate to said specific poker hands.

2. The method according to claim 1, said method further comprising the steps of:
providing the compiled list of the indexed playing cards that correlate to said specific poker hands in a form selected from the group consisting of: a printed felt covering a table, a publically available source on an internet website, a game having a board, a printed publication for playing the game, a publically visible wall in a casino, or labeled diagram, a letter to a gaming commission, or a combination thereof.

3. A method for playing a card game, said method comprising the steps of:
utilizing a compiled list of indexed playing cards that correlates by said strength ranking to said specific poker hands, where a missing indexed playing card from a deck does not invalidate the results of a hand;
placing an ante, by or for each player, in a predetermined common betting space, typically referred to as a pot, therein determining a plurality of active players;
dealing, by hand or via a similar mechanical or an electronic gaming device simulation thereof, to each active player an indexed playing card that is dealt facedown, where each indexed playing card correlates to a specific poker hand;
viewing, optionally, by the plurality of active players their respective a face-down side of each dealt indexed playing card;
checking the compiled list to determine the strength ranking and specific poker hands correlating to the dealt indexed playing card;
determining if any of the plurality of active players want to make a bet;
betting until all of the active players that are betting calls; and
revealing the dealt indexed playing card of each of the active players that is betting;
determining if there is a winning poker hand or if there are ties, where two or more active players have hands of equal strength rank;
assuming there are no ties, the active player with the winning poker hand wins the ante and any bets;
breaking the ties steps by dealing face-down a second indexed playing card to each tied active players;
viewing, optionally, by the tied active players their respective second face-down side of the second indexed playing card;
checking the compiled list to determine the strength ranking and specific poker hands correlating to the second indexed playing card;
determining if any of the tied active players want to make another bet;
betting until all of the tied active players that is betting calls;
revealing the second dealt indexed playing card of the tied active players;
determining if there is a winning poker hand or if there is another tie, where two or more tied active players have hands of equal strength rank;
assuming there are no ties, the active player with the winning poker hand wins the ante and any bets; otherwise
breaking a cycle of ties using “breaking the ties steps”.

4. The method according to claim 3, said method further comprising the steps of:
providing the compiled list as a labeled diagram showing the indexed poker playing cards that correlate to said specific type poker hands and their strength ranking in a format suitable for playing a game where you draw only one playing card, wherein a preferred format includes a casino printed felt covering a table.

5. A method for playing, in gaming venues such as a casino, a card game, said method comprising the steps of:
utilizing a compiled list of indexed playing cards that correlates by said strength ranking to said specific poker hands, wherein a subset of the compiled list is made therein forming a plurality of one show cards, where a missing indexed playing card from a deck does not invalidate the results of a hand;
providing the plurality of playing cards as a labeled diagram showing the indexed poker playing cards that correlate to said specific type poker hands and their strength ranking in a format suitable for playing the game of casino, wherein a preferred format includes a printed felt covering a table;
adding at least one joker to the plurality of playing cards, wherein when the at least one joker is generated either by dealing by hand or via a similar mechanical or an electronic gaming device simulation thereof, wherein if the at least one joker is generated the casino wins all bets, with a singular exception of an active player who has bet that a joker will be generated, said active player also wins;
providing common betting spaces on the labeled diagram, wherein active players can place a bet directly on the casino printed felt, or remotely utilizing an electronic medium selected from the group consisting of a web page on the internet, zoom and similar video applications, a telephonic medium, and simulations of the game;
announcing by a game facilitator that the game is open for placing bets;
facilitating active players to place bets;
announcing by the game facilitator that the betting period is closed;
generating a face-up card from the sub-selection that matches the labeled diagram that includes a plurality common betting spaces of various paying odds selected from the group consisting of: a specific playing card, a suit, a poker hand type, a range of strength rankings, the at least one joker and combinations thereof;
determining by the game facilitator whether a bet is a winning bet or a losing bet;
collecting losing bets by the game facilitator; and
paying the winning bets, therein explaining the paying odds on the labeled diagram so that, collectively, the active players better understand the game.

6. The method according to claim 5, said method further comprising the steps of:
providing active players common betting spaces to bet on a group of betting spaces consisting of: a plurality of single indexed poker playing cards; each of the four card suits, one or more of the eight types of poker hands, a plurality of the rankings of a type of poker hand, and combinations thereof.

7. A diagram that facilitates a visual correlation of a specific playing card to a specific poker hand, said diagram comprising:
a plurality of at least three overlapping circles having a common center comprised of an inner circle, a middle circle, and an outer circle;
wherein a pair of orthogonal lines passing through the common center divide the overlapping circles into four quadrants, wherein each quadrant is a specific suit;
wherein each of the four quadrants is divided by a plurality of radial lines extending from the inner circle to the outer circle creating a plurality of poker hand type spaces;
a plurality of radial shorter lines extending from the middle circle to the outer circle therein subdividing at least one poker hand type space and also creating a plurality of specific playing card spaces, wherein the specific playing card has a face or a numeric value that is indicative of a specific poker hand; and
a plurality of strength rankings outside of the outer circle and adjacent to the specific playing card, wherein a strength ranking for a poker hand is visually and numerically associated with an adjacent playing card.

8. The diagram according to claim 7 further comprises: at least one betting space for a joker.

9. The diagram according to claim 7 further comprises: at least one betting space for a plurality of a range of strength rankings, at least one betting space for one or more suits, at least one betting space for one or more poker hand types, and at least one betting space for a plurality of one or more of the specific playing cards.
